(19) United States
(12) Patent Application Publication
(10) Pub. No.: US 2019/0160339 A1
(43) Pub. Date: May 30, 2019

(54) SYSTEM AND APPARATUS FOR IMMERSIVE AND INTERACTIVE MACHINE-BASED STRENGTH TRAINING USING VIRTUAL REALITY

(71) Applicant: Board of Trustees of Michigan State University, East Lansing, MI (US)

(72) Inventors: Mi Zhang, Okemos, MI (US); Taiwoo Park, East Lansing, MI (US); Biyi Fang, Lansing, MI (US)

(21) Appl. No.: 16/204,887

(22) Filed: Nov. 29, 2018

Related U.S. Application Data
(60) Provisional application No. 62/592,236, filed on Nov. 29, 2017.

(51) Int. Cl. A63B 24/00; G06K 9/00; H04L 29/08; G06T 13/40; A63F 13/816; A63F 13/211; A63B 71/06

(52) U.S. Cl. CPC A63B 24/0087; A63B 2071/0666; H04L 67/12; G06T 13/40; A63F 13/816; A63F 13/211; A63B 71/0622; A63B 2024/0096; A63B 2024/0071; A63B 2024/0065; A63B 2024/0068; A63B 2220/803; A63B 2220/833; A63B 2225/52; A63F 2300/8082; A63B 2071/0638; A63B 2071/065; G06K 9/00342

(57) ABSTRACT

Virtual reality and communicative sensing devices may be applied to immersive and interactive exercise. Systems and methods may be used to capture a user's movements during exercise and use captured movement information to update sensory stimuli presented to the user via a head mounted display to create an illusion of being immersed in a virtual environment in which the user can interact. This movement information may be captured using an internet of things (IoT) sensor attached to, in communication with, or integrated into exercise equipment being operated by the user. The IoT sensor may identify exercise type, count the number of repetitions, and assess the quality of the exercise being performed by the user.

### CROSS REFERENCE TO RELATED APPLICATIONS

This application claims priority to U.S. Provisional Application No. 62/592,236 filed Nov. 29, 2017, which is incorporated by reference in its entirety for all purposes.

### STATEMENT REGARDING FEDERALLY SPONSORED RESEARCH

None

### BACKGROUND

Obesity is a growing problem with more than one-third of American adults being classified as obese. Obesity increases the risk of certain chronic diseases such as Type II diabetes. Exercising has been shown to improve the health of individuals and lower the risk of obesity-related diseases. Despite these health benefits, many individuals still remain inactive. This could be due to lack of motivation, due to the physical effort or monotony sometimes perceived as being associated with exercise.

Exergaming (a portmanteau of “exercise” and “gaming”) has emerged as a solution to this problem. Exergaming is a class of video games that requires participants to be physically active in order to play the game, thereby turning tedious exercising into a fun and interactive exercise experience for users. Game genres may vary from action based to health and fitness focused. These technologies however, have several limitations. First, a television is often required to display these games. Second, the user is often required to hold a game controller in order to capture their physical movements. This limits the types of exercises the user can perform and is often an added physical burden.

In light of the above, there remains a need for improved systems and methods for immersive and interactive exercise.

### SUMMARY

The present disclosure generally relates to virtual reality and communicative sensing devices as applied to immersive and interactive exercise. More specifically, the present disclosure is directed to systems and methods that capture a user's movements during exercise and use captured movement information to update sensory stimuli presented to the user via a head mounted display to create an illusion of being immersed in a virtual environment in which the user can interact. In one embodiment, this movement information may be captured using an internet of things (IoT) sensor attached to, in communication with, or integrated into exercise equipment being operated by the user. The IoT sensor may identify exercise type, count the number of repetitions, and assess the quality of the exercise being performed by the user.

In an example embodiment, a method may include, with a sensor device, detecting motion and generating motion data based on the detected motion, with an electronic device, receiving the motion data from the sensor device, with a processor in the electronic device, analyzing the motion data to produce analytics information, with the processor, generating a virtual reality (VR) environment in which analytics information is provided, and with an electronic display in the electronic device, displaying the VR environment.

In some embodiments, analyzing the motion data to produce the analytics information may include segmenting the motion data into repetition segments, each corresponding to a single repetition of an exercise, generating a repetition count corresponding to a quantity of the repetition segments, generating a motion progress status corresponding to a percentage of a given repetition that has been completed in real-time, determining an exercise type based on the motion data, and determining exercise quality based on the motion data.

In some embodiments, the motion data may include acceleration data, and segmenting the motion data to produce the repetition segments includes performing principle component analysis on the acceleration data to generate a first principle component signal, and identifying a repetition segment of the motion data corresponding to a first repetition of the exercise based on the first principle component signal and the acceleration data.

In some embodiments, generating the motion progress status may include generating the motion progress status based on a comparison between the first principle component signal to a historical first principle component signal.

In some embodiments, the motion data may also include gyroscope data, and determining the exercise type based on the motion data includes generating an acceleration magnitude signal for the acceleration data, generating a rotational magnitude signal for the gyroscope data, extracting features from the acceleration magnitude signal and the rotational magnitude signal to generate a feature vector, and analyzing the feature vector to determine the exercise type by applying a majority voting scheme to the feature vector for multiple repetitions of the exercise.

In some embodiments, determining exercise quality based on the motion data may include comparing the motion data to a trainer model stored in a non-transitory memory of the electronic device.

In some embodiments, comparing the motion data to the trainer model may include dividing the repetition segments into smaller fixed-length windows, generating a first motion trajectory for the motion data by extracting features from each window of the windows to generate a sequence of local feature vectors, and performing trajectory comparison on the first motion trajectory and a second motion trajectory of the trainer model.

In some embodiments, the trajectory comparison may include multidimensional dynamic time warping.

In some embodiments, generating the VR environment may include animating an avatar that moves in real-time corresponding to the motion data, highlighting muscle groups on the avatar that correspond to muscles activated by the determined exercise type, and generating a heads-up display (HUD) that includes the repetition count, the motion progress status, the exercise type, and the exercise quality.

In an example embodiment, a system may include a sensor device that captures motion data corresponding to motion of an exercise machine, and an electronic device that receives the motion data from the sensor device. The electronic device may include a processor connected to a memory having instructions stored thereon which, when executed by the processor, cause the processor to analyze the motion data to produce analytics information, and generate a virtual reality (VR) environment in which the analytics information is provided, and an electronic display electrically coupled to the processor to display the VR environment generated by the processor.

In some embodiments, the sensor device may include a magnet that attaches the sensor device to the exercise machine.

In some embodiments, the sensor device may include wireless communications circuitry that provides the motion data to the electronic device via Bluetooth Low Energy.

In some embodiments, the processor may further execute instructions for segmenting the motion data into repetition segments, each corresponding to a single repetition of an exercise, generating a repetition count corresponding to a quantity of the repetition segments, generating a motion progress status corresponding to a percentage of a given repetition that has been completed in real-time, determining an exercise type based on the motion data, and determining exercise quality based on the motion data.

In some embodiments, the processor may further execute instructions for dividing the repetition segments into smaller fixed-length windows, generating a first motion trajectory for the motion data by extracting features from each window of the windows to generate a sequence of local feature vectors, and performing trajectory comparison on the first motion trajectory and a second motion trajectory of a trainer model to determine the exercise quality. The trainer model may be stored in a trainer reference database in a non-transitory memory of the electronic device.

In some embodiments, the sensor device may also include an accelerometer that generates acceleration data and a gyroscope that generates gyroscope data. The captured motion data may include the acceleration data and the gyroscope data.

In an example embodiment, a head-mounted display (HMD) device may include a processor connected to a memory having instructions stored thereon which, when executed by the processor, cause the processor to analyze captured motion data to produce analytics information, and generate a virtual reality (VR) environment in which the analytics information is provided, and an electronic display electrically coupled to the processor to display the VR environment generated by the processor.

In some embodiments, the memory contains further instructions which, when executed by the processor, cause the processor to segment the motion data into repetition segments, each corresponding to a single repetition of an exercise, generate a repetition count corresponding to a quantity of the repetition segments, generate a motion progress status corresponding to a percentage of a given repetition that has been completed in real-time, determine an exercise type based on the motion data, and determine exercise quality based on the motion data.

In some embodiments the memory contains further instructions which, when executed by the processor, cause the processor to divide the repetition segments into smaller fixed-length windows, generate a first motion trajectory for the motion data by extracting features from each window of the windows to generate a sequence of local feature vectors, and perform trajectory comparison on the first motion trajectory and a second motion trajectory of a trainer model to determine the exercise quality.

In some embodiments, the HMD device may also include a non-transitory computer readable storage medium. The trainer model may be stored in a trainer reference database in a non-transitory computer readable storage medium.

In some embodiments, the VR environment may include an animated avatar that moves in real-time corresponding to the motion data to perform the exercise, and a heads-up display (HUD) that includes the repetition count, the motion progress status, the exercise type, and the exercise quality in real-time. The animated avatar may include highlighted muscle groups corresponding to muscles activated by the determined exercise type.

### BRIEF DESCRIPTION OF THE DRAWINGS

The present invention will hereafter be described with reference to the accompanying drawings, wherein like reference numerals denote like elements.

The patent or application file contains at least one drawing executed in color. Copies of this patent or patent application publication with color drawing(s) will be provided by the Office upon request and payment of the necessary fee.

FIG. 1 is an illustrative block diagram showing an electronic device which may be used as part of a virtual reality (VR) system, in accordance with aspects of the present disclosure.

FIG. 2 is an illustrative block diagram showing a sensor device which may generate exercise movement data and may provide the exercise movement data to a VR system, in accordance with aspects of the present disclosure.

FIG. 3 is an illustrative depiction of a head mounted display that maybe used to implement a VR system, in accordance with aspects of the present disclosure.

FIG. 4A is a front view of an embodiment of a sensor device assembly, in accordance with aspects of the present disclosure.

FIG. 4B is a rear view of an embodiment of a sensor device assembly, in accordance with aspects of the present disclosure.

FIG. 5 is an array of exercise devices in or on which a sensor device may be operatively disposed in accordance with aspects of the present disclosure.

FIG. 6 is a depiction of exercise devices on which sensors have been placed, in accordance with aspects of the present disclosure.

FIG. 7 is an illustrative diagram showing a real-time exercise analytics engine and a VR synthesis engine which may be used in combination to generate and display a VR user interface based on exercise motion data, in accordance with aspects of the present disclosure.

FIG. 8 includes illustrative graphs showing acceleration data over time corresponding to the performance of a pulldown exercise and a seated abs exercise, as well as principle components extracted from the acceleration data for each exercise, in accordance with aspects of the present disclosure.

FIG. 9 shows illustrative graphs, each comparing exercise movement data for one repetition of an exercise performed by a user to store exercise movement data corresponding to one repetition of the exercise performed by a professional trainer, in accordance with aspects of the present disclosure.

FIG. 10 is an illustrative depiction of a user interface that may be displayed by a VR system, in accordance with aspects of the present disclosure.

### DETAILED DESCRIPTION

The present disclosure relates to systems and methods for immersive and interactive machine-based exercise training using VR.

Exercising in the gym has become an important part of modern life for many people. However, without the guidance of professional trainers, novice exercisers may be unaware if the quality of the speed and motion of an exercise they perform is adequate or what they should focus on during a workout. This lack of awareness often prevents exercisers from making steady progress, and may eventually cause exercisers to lose interest and motivation for going to the gym.

In order to enhance an individual's interest and motivation for exercise, as well as to improve the quality of exercise, an immersive and interactive VR exercising experience is provided, through which controllable 3D stimulus environments may be created. As part of this VR exercising experience, an engaged virtual exercise assistant may guide exercisers in a highly interactive and precise way, which may not be achievable through traditional exercise training paradigms.

Immersive and interactive machine-based exercise training may be enabled through the use of miniature IoT sensing devices communicatively coupled to a mobile head mounted display (HMD) device. By attaching (directly or indirectly) an IoT sensing device on any piece of gym equipment, exercise progress may be continuously tracked, and exercise quality may be assessed in real-time. By providing captured exercise progress information and quality information as inputs of a VR environment implemented on the HMD device, an immersive exercise experience is created in which a user may be guided through the process of exercising by a virtual exercise assistant using real-time feedback. Additionally, by highlighting, on an avatar shown in the VR environment, required muscle groups corresponding to the exercise being performed, the virtual exercise assistant may enable a user to more easily focus on these muscle groups while performing the exercise.

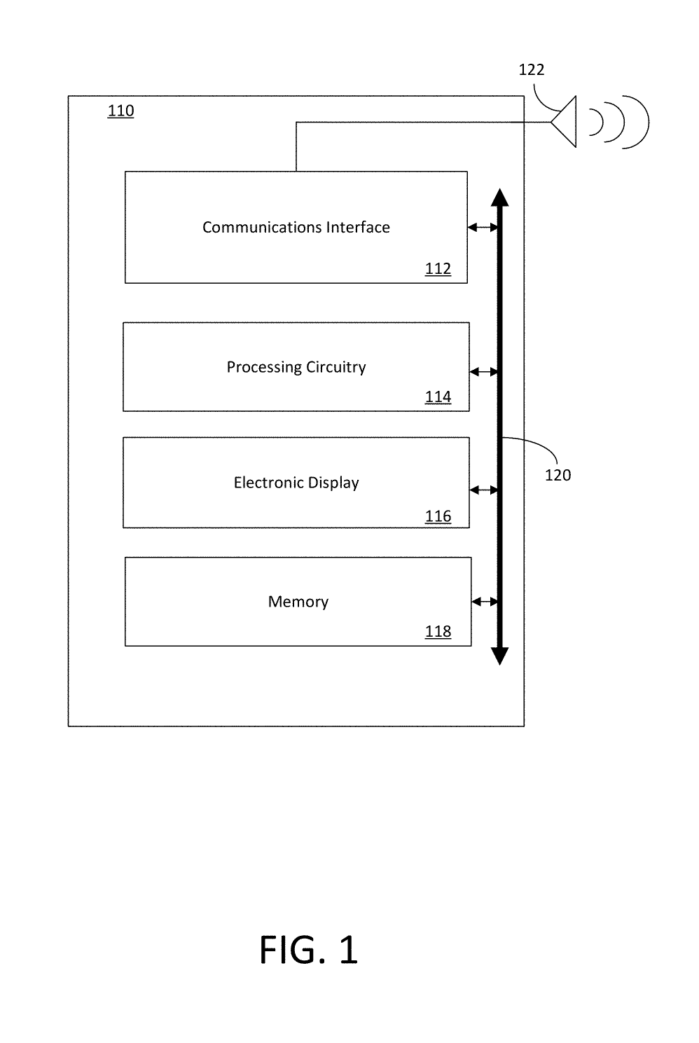

Turning now to FIG. 1, a block diagram of an example system 110 (e.g., a VR HMD system), is shown. As an illustrative, non-limiting example, system 110 could be a portable electronic device, such as smartphone or a dedicated VR headset.

System 110 includes a communications interface 112, processing circuitry 114, an electronic display 116, a memory 118, and an antenna 122. Some or all of these components may communicate over a bus 120. Although bus 120 is illustrated here as a single bus, it may instead be implemented as one or more busses, bridges, or other communication paths used to interconnect components of system 110. Memory 118 may be a non-transitory computer readable storage medium (e.g., read-only memory (ROM), random access memory (RAM), flash memory, etc.). Processing circuitry 114 may include one or more hardware processors, which may execute instructions stored in memory 118. These instructions may, for example, include instructions for determining exercise type, tracking exercise progress, assessing exercise quality, generating a VR scene, visualizing exercise information, and animating a virtual body (e.g., an avatar). Electronic display 116 may display a VR scene, exercise information, and an animated virtual body (e.g., all generated by processing circuitry 114) all corresponding to an exercise being performed by a user in real-time.

Communications interface 112 may include one or more communications interfaces, each configured to operate according to a different wireless communications protocol (e.g., Bluetooth, Bluetooth Low Energy (LE), WiFi, WiMAX, LTE, LTE-Advanced, GSM/EDGE). Antenna 122 may wirelessly transmit and receive data between communications interface 112 and external devices. It should be noted that while antenna 122 is shown here as being a single antenna that is external to system 110, in some embodiments, antenna 122 may instead include multiple antennas located in or at various locations of system 110, and/or may be disposed within or formed as part of a housing of system 110.

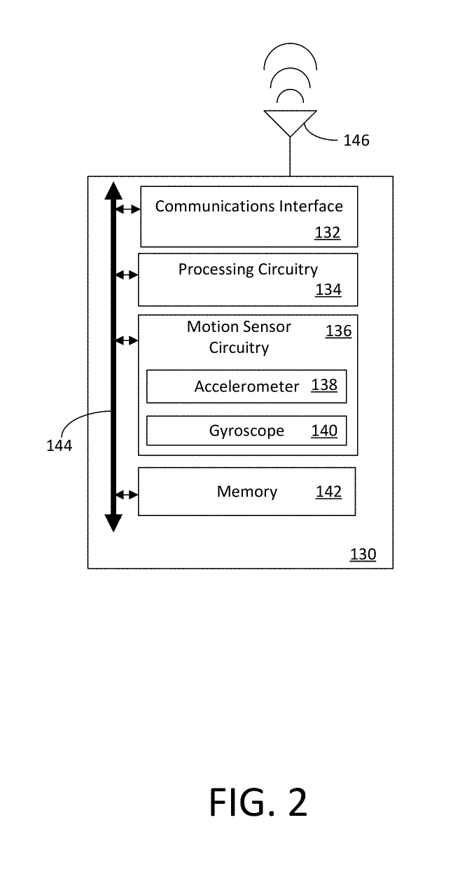

Turning now to FIG. 2, a block diagram of an example sensor device 130 (e.g., a Bluetooth LE sensor tag), is shown. Sensor device 130 may be in communication with (e.g., directly or indirectly attached to) or integrated within a piece of exercise equipment (e.g., an exercise machine). Sensor device 130 may, for example, be used in conjunction with system 110 of FIG. 1 in order to translate captured motion data corresponding to an exercise being performed by a user into exercise analytics information and a VR representation of the exercise being performed.

Sensor device 130 includes a communications interface 132, processing circuitry 134, motion sensor circuitry 136, a memory 142, and an antenna 146. Some or all of these components may communicate over a bus 144. Although bus 144 is illustrated here as a single bus, it may instead be implemented as one or more busses, bridges, or other communication paths used to interconnect components of sensor device 130. Memory 142 may be a non-transitory computer readable storage medium (e.g., read-only memory (ROM), random access memory (RAM), flash memory, etc.). Processing circuitry 134 may include one or more hardware processors, which may execute instructions stored in memory 118. These instructions may, for example, include instructions for controlling motion sensor circuitry 136 and communications interface 132. In some embodiments, processing circuitry 134 may be a microcontroller unit.

Motion sensor circuitry 136 may include an accelerometer 138, a gyroscope 140, and/or other sensors capable of discerning relative movement. Accelerometer 138 may, for example, be a 3-axis accelerometer, which may measure linear acceleration undergone by sensor device 130 in one or more directions. Gyroscope 140 may, for example, be a 3-axis gyroscope, which may measure the angular rate of rotational movement about one or more axes of sensor device 130 accurately in multiple dimensions. Motion sensor circuitry 136 may generate motion data at a given sampling rate (e.g., 10 Hz). A moving average filter (e.g., with length 10) may be applied (e.g., by processing circuitry 134) to the generated motion data in order to suppress high frequency noise that may be present in the motion data. Motion data generated by motion sensor circuitry 136 may be provided to an external VR HMD system (e.g., system 110 of FIG. 1), and may be used as a basis for exercise analytics and corresponding VR synthesis (e.g., performed by processing circuitry 114 of system 110 of FIG. 1). In some embodiments, sensor device 130 may receive exercise analytics data from an external VR HMD system to which sensor device 130 has sent corresponding motion data, and sensor 130 may store the exercise analytics data on the memory 142. In some embodiments, exercise analytics may be performed by processing circuitry 134 to generate exercise analytics data, which may be stored on memory 142. In some embodiments, the motion data generated by motion sensor 136 may also be stored on memory 142.

Communications interface 132 may include one or more communications interfaces, each configured to operate according to a different wireless communications protocol, such as Bluetooth LE. Antenna 146 may wirelessly transmit and receive data between communications interface 132 and external devices (e.g., system 110 of FIG. 1). It should be noted that while antenna 146 is shown here as being a single antenna that is external to the main body of sensor device 130, in some embodiments, antenna 146 may instead include multiple antennas located in or at various locations of sensor device 130, and/or may be disposed within or formed as part of a housing of sensor device 130. In some embodiments, antenna 146 may be an inverted-F antenna formed on a printed circuit board (PCB). In some embodiments, sensor device 130 may be configured to automatically send motion data and/or exercise analytics data stored on memory 142 to a user device (e.g., a smart phone or tablet) to which it connects via communications interface 132. The motion and/or exercise analytics data may then be stored on a memory device of the user device and/or may be uploaded to a remote memory device (e.g., of a cloud server) by the user device.

While not shown here, sensor device 130 may include a plastic or otherwise dielectric housing in which a magnet is embedded. In this way, sensor device 130 may be easily attached to, for example, ferromagnetic exercise equipment.

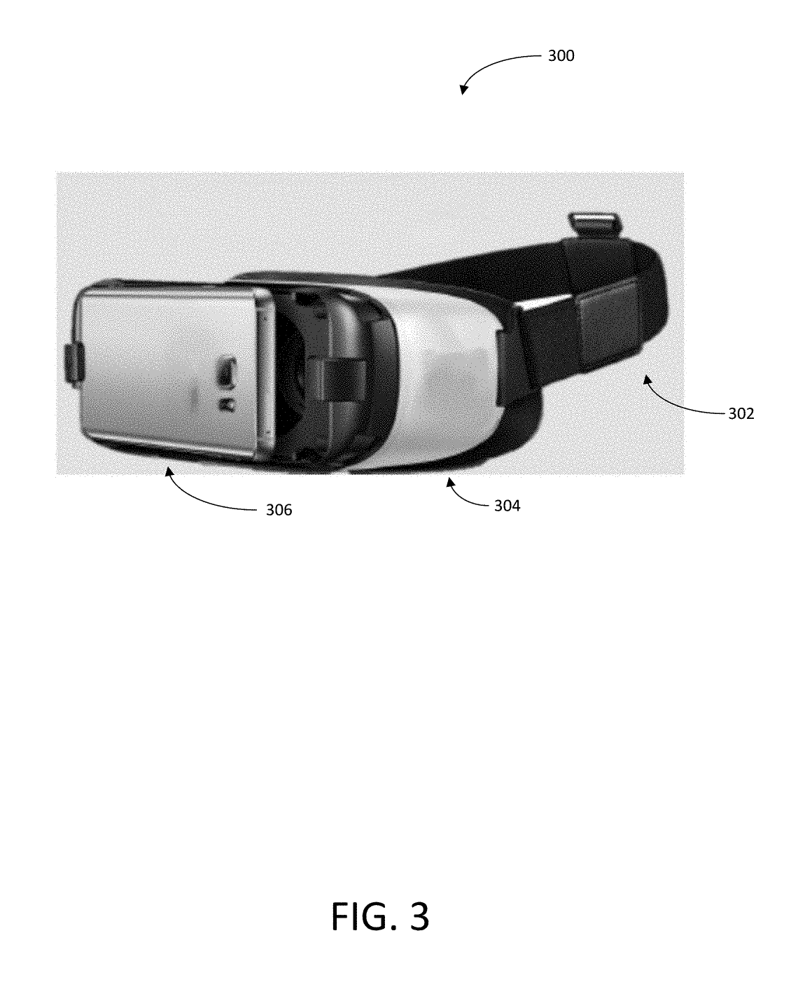

FIG. 3 shows an example of a HMD 300, which may correspond to one possible implementation of system 110 of FIG. 1. As shown, HMD 300 includes a head-strap 302, a light blocking frame member 304, and an electronic device 306. As shown, electronic device 306 may be a smartphone or other portable electronic device having an electronic display. HMD 300 may, for example, be worn by a user when the user is performing an exercise or set of exercise, and may generate a VR environment to the user, in which an animated avatar may mimic the user's performance of an exercise in approximately real-time, and in which analytic information corresponding to the user's performance of the exercise may be displayed (e.g., as part of a heads-up display (HUD)).

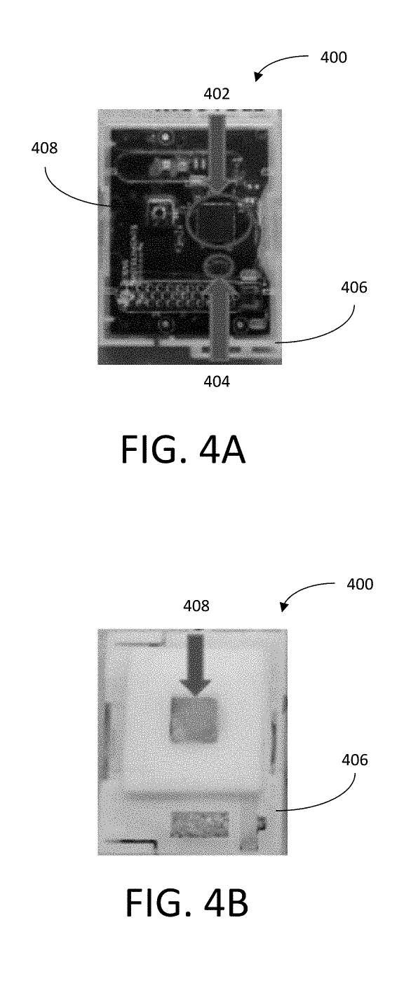

Turning now to FIGS. 4A and 4B, front-facing and back-facing views of an example of a sensor tag 400, which may correspond to one possible implementation of sensor device 130 of FIG. 2, are shown.

As shown in FIG. 4A, sensor tag 400 may include multiple chips and interconnects formed or otherwise disposed on a substrate 408, which may be a PCB. Substrate 408 may be at least partially located within a housing 406, which may be formed from plastic or another dielectric material. Among the chips included on substrate 408 are a microcontroller unit (MCU) 402 and a motion sensor 404. MCU 402 may, for example, be a multi-standard wireless MCU with Bluetooth LE communications capabilities. Motion sensor 404 may include a 3-axis accelerometer and a 3-axis gyroscope. Sensor tag 400 may also include a serial flash memory (not shown), which may, for example, store instructions for operating motion sensor 404 and MCU 402. As shown in FIG. 4B, housing 406 of sensor tag 400 may include an embedded magnet 408, which may allow sensor tag 400 to be directly attached to ferromagnetic exercise equipment, thereby allowing sensor tag 400 to detect the motion of the exercise equipment. In this way, sensor tag 400 may be considered a “machine-wearable” sensing device. Compared to traditional human-wearable sensing devices (e.g., smartphones, smartwatches, and armbands; referred to herein as “human-wearables”), machine-wearables have several advantages. For example, machine-wearables can capture abdominal and lower limb machine exercise that human-wearables may fail to capture (e.g., considering that human-wearables are generally worn on a user's arms/wrists). As another example, machine-wearables may distinctly capture an exercise machine's constrained movements without capturing superfluous motion data (e.g., corresponding to non-exercise body movements), thereby providing cleaner motion data than human-wearables are capable of providing without the need for the significant signal processing that would be required to filter out superfluous motion data. Additionally, the ability of sensor tag 400 to be attached and detached from exercise equipment allows for portability of sensor tag 400. For example, a user may attach sensor tag 400 to a first exercise machine at a first gym (e.g., a home gym), remove sensor tag 400 from the first exercise machine after exercising, travel to a second gym (e.g., a commercial gym facility or a hotel gym), and attach sensor tag 400 to a second exercise machine at the second gym.

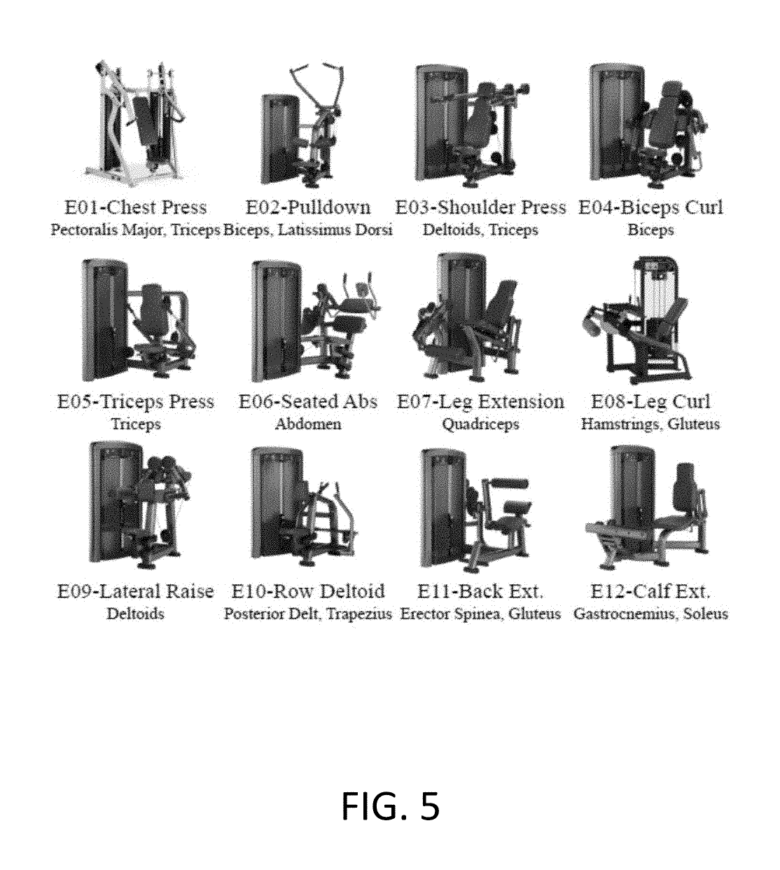

Turning now to FIG. 5, various examples of exercise machines with which embodiments of the present disclosure may be utilized are shown, and the muscle groups targeted by each exercise machine are listed. These exercise machines represent the most commonly used types of machine exercise that target different muscle groups on the body. It should be noted that, for a given exercise machine, the placement of the sensor tag (e.g., sensor device 130 or sensor tag 400 of FIGS. 1 and 4) on the exercise machine may differ compared to the placement of the sensor tag on other exercise machines, according at least in part to the portion(s) of the given exercise machine that correspond to the primary motion associated with the exercise performed using that machine. As will be described, motion data generated by a sensor tag on an exercise machine may be used as a basis for identifying the exercise type being performed using that exercise machine.

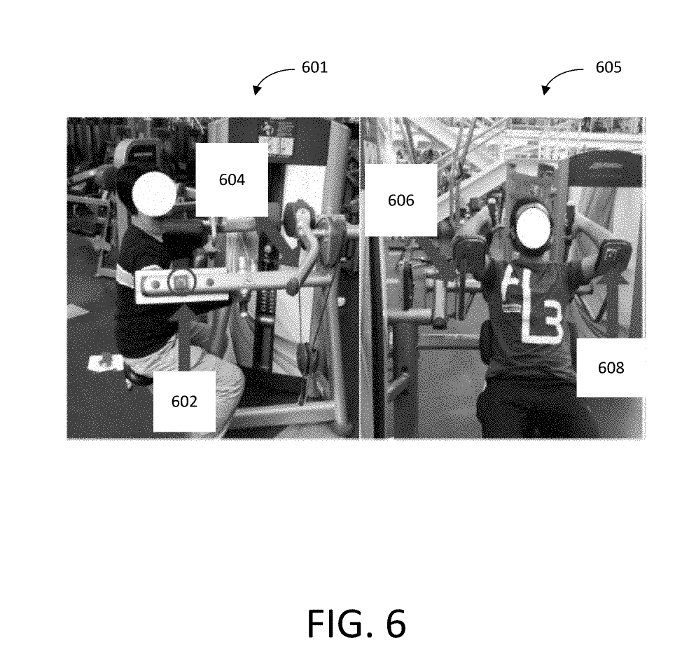

Turning now to FIG. 6, two examples of possible placement of sensor tags (e.g., sensor device 130 and sensor tag 400 of FIGS. 1 and 4) on two different exercise machines are shown when determining an optimal placement of a sensor tag on each exercise machine for accurate exercise type identification.

First, for lateral raise machine 601, a sensor tag 602 may be attached to a first portion of lateral raise machine 601. While lateral raise machine 601 is in use, the motion of this first portion corresponds to the primary motion associated with the performance of a lateral raise. Additionally, a sensor tag 604 may be attached to a second portion of lateral raise machine 601. While lateral raise machine 601 is in use, the motion of the second portion corresponds to a different angle/trajectory compared to the motion of the first portion of lateral raise machine 601.

Second, for seated abs machine 605, a sensor tag 608 may be attached to a first portion of seated abs machine 605 in a first orientation. Additionally, a sensor tag 606 may be attached to a second portion of seated abs machine 605 in a second orientation (e.g., arranged along a plane that is perpendicular to the plane along which sensor tag 608 is arranged).

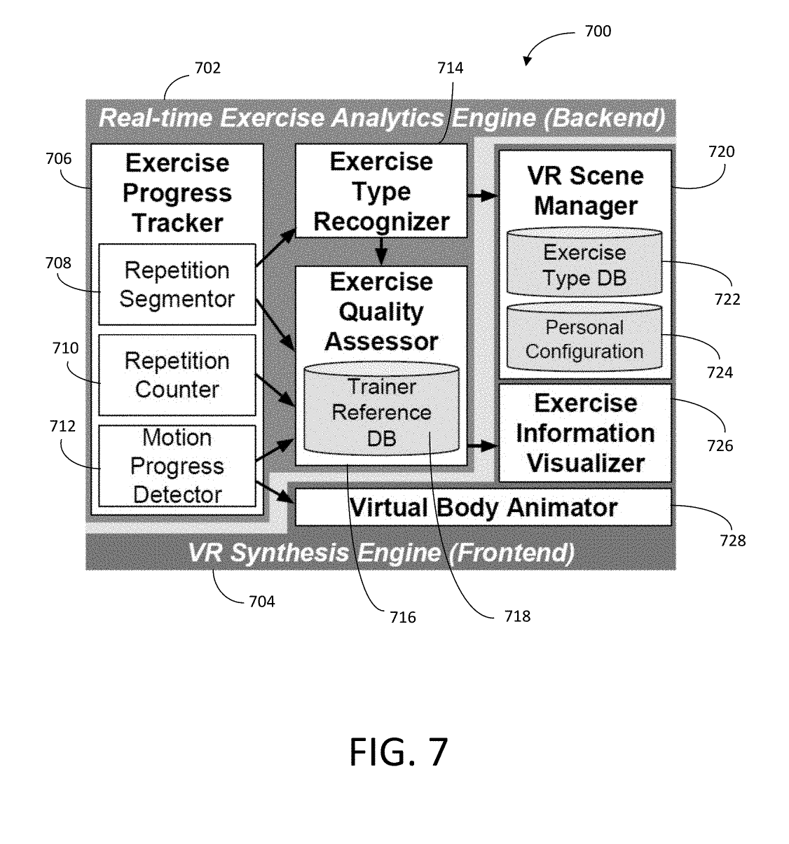

By attaching a second sensor tag to an exercise machine with a slightly different angle/trajectory of motion and/or orientation compared to that of a first sensor tag attached to the exercise machine, motion data from both sensor tags may be analyzed to determine the optimal sensor tag placement on the exercise machine for accurate identification of exercise type (e.g., by exercise type recognizer 712 of FIG. 7).

For example, for embodiments in which “N” exercise types corresponding to “N” different exercise machines are identifiable (e.g., by system 110 of FIG. 1), data may be collected from first and second sensor tags (e.g., sensor tags 602 and 604; sensor tags 606 and 608) placed at different locations on each of the “N” exercise machines. For a given exercise machine of the “N” different exercise machines, a predetermined number of repetitions (e.g., 10 repetitions) of an exercise may be performed using the given exercise machine, while corresponding motion data is generated by the first and second sensor tags. This process may be repeated with each of the “N” different exercise machines.

Different sensor placement combinations (e.g., arranged in motion data arrays) may then be analyzed (e.g., by exercise type recognizer 712 of FIG. 7) to determine an optimal sensor tag placement for each exercise machine. For a given sensor tag placement combination, corresponding motion data is analyzed (e.g., by exercise type recognizer 712 of FIG. 7) to identify a corresponding exercise type. This identified exercise type is then compared to the actual exercise type to determine whether the exercise type was identified correctly. This process may be repeated multiple times for each possible sensor tag placement combination in order to aggregately determine accuracy for each possible sensor tag placement combination. In the present example, motion data generated by the first sensor tag on a first exercise machine may be defined as m1s1, motion data generated by the second sensor tag on the first exercise machine may be defined as m1s2, motion data generated by the first sensor tag on a second exercise machine may be defined as m2s1, motion data generated by the second sensor tag on the second exercise machine may be defined as m2s2, and so on. The analyzed motion data arrays may be expressed as (m1s1, m2s1, m3s1, . . . , mNs1), (m1s2, m2s1, m3s1, . . . , mNs1), (m1s1, m2s2, m3s1, . . . , mNs1), (m1s2, m2s2, m3s1, . . . , mNs1), . . . , (m1s2, m2s2, m3s2, . . . , mNs2). In this way, each of the 2^{N} possible sensor tag placement combinations are analyzed for accuracy to determine the sensor tag placement combination that allows exercise type to be identified most accurately. Once the optimal sensor tag placement has been determined for a given exercise machine, the placement may be physically marked on the exercise machine, or may be displayed to a user on an electronic display (e.g., electronic display 116 of system 110).

Turning now to FIG. 7, a system architecture 700 is shown, which may be implemented by a VR system (e.g., by executing instructions using processing circuitry 114 of system 110 of FIG. 1) to analyze captured motion data (e.g., captured from a sensor device such as sensor device 130 or sensor tag 400 of FIGS. 1 and 4) responding to an exercise performed by a user, and to generate a VR environment in which exercise information is displayed and in which an animated avatar is displayed, which mimics the exercise motion performed by the user in real-time. System architecture 700 includes a real-time exercise analytics engine 702 and a VR synthesis engine 704. Real-time exercise analytics engine 702 includes an exercise progress tracker 706, an exercise type recognizer 714, and an exercise quality assessor 716. Exercise progress tracker 706 includes a repetition segmentor 708, a repetition counter 710, and a motion progress detector 712.

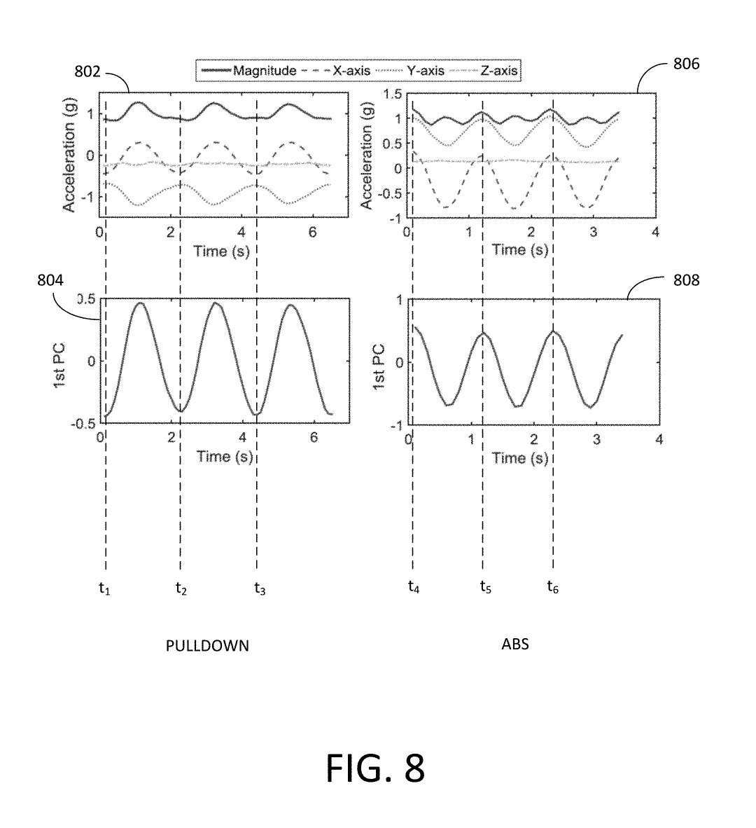

Repetition segmentor 708 may distinguish between separate repetitions of an exercise by segmenting captured motion data. The goal of repetition segmentation performed by repetition segmentor 708 is to segment streaming sensor data (e.g., captured motion data) so that each data segment contains one complete repetition of the performed machine exercise. Examples of how repetition segmentor 708 may operate will be described herein in the context of FIG. 8. Graphs illustrating two separate examples of 3-axis acceleration data (e.g., a subset of the captured motion data for a user; produced by an 3-axis accelerometer such as accelerometer 138 of FIG. 2) associated with the performance of a pulldown exercise and a seated abs exercise, respectively, are shown in FIG. 8, as well as graphs of first principal component (PC) signals extracted from the acceleration data for each exercise. Graph 802 illustrates the acceleration data corresponding to the performance of multiple repetitions of a pulldown exercise by a user, including overall acceleration magnitude, x-axis acceleration data, y-axis acceleration data, and z-axis acceleration data. Graph 806 illustrates the acceleration data corresponding to the performance of multiple repetitions of a seated abs exercise by a user, including overall acceleration magnitude, x-axis acceleration data, y-axis acceleration data, and z-axis acceleration data. Because a user may place a sensor tag (e.g., sensor device 130 or sensor tag 400 of FIGS. 2 and 4) on exercise machines in different ways, leading to different sensor tag orientations, one scheme to capture orientation-independent motion data from the sensor tag is to derive an orientation-independent acceleration magnitude signal from the acceleration data and to apply peak detection to the acceleration magnitude signal in order to segment the captured motion data for the exercise. However, such a scheme may be unsuitable in the context of machine exercises because different machines exercises may have different numbers of acceleration magnitude peaks and valleys for each repetition. For example, as shown in graph 802, a pulldown exercise has an acceleration magnitude signal with one peak and two valleys per repetition. In contrast, as shown in graph 806, a seated abs exercise has an acceleration magnitude signal with three peaks and two valleys per repetition. Without knowing the exercise type being performed in advance, the application of peak detection to the acceleration magnitude signal may undesirably cause a single repetition of an exercise to be split into multiple segments. Thus, it may be beneficial to perform principle component analysis (PCA) when segmenting repetitions from the acceleration data to derive a first PC signal from the acceleration data. Given a set of points in Euclidean space, the first PC corresponds to a line that passes through the multidimensional mean and minimizes the sum of squares of the distances of the points from the line. Graph 804 illustrates a first PC signal derived from the 3-axis acceleration data of graph 802 corresponding to the performance of the pulldown exercise. Based on the first PC signal of graph 804, repetition segmentor 708 may determine that a first repetition of the pulldown exercise occurs beginning at time t₁ and ending at time t₂ and that a second repetition of the pulldown exercise occurs beginning at time t₂, and ending at time t₃. Similarly, graph 808 illustrates a first PC signal derived from the 3-axis acceleration data of graph 806 corresponding to the performance of the seated abs exercise. Based on the first PC signal of graph 808, repetition segmentor 708 may determine that a first repetition of the seated abs exercise occurs beginning at time t₄ and ending at time t₅, and that a second repetition occurs beginning at time is and ending at time t₆. In this way, repetition segmentor 708 may continuously segment incoming captured motion data in real-time.

Repetition counter 710 may increment a counter value each time a new repetition is identified by repetition segmentor 708, where the counter value represents the total number of exercise repetitions that have been performed. A user may have the option (e.g., via a user interface) to reset this counter between different sets of the exercise being performed.

It is challenging to provide a user with precise progress information corresponding to the percentage of a repetition that has been completed in real-time, as the exact progress status within each repetition can only be determined after a repetition has been completed. This is due in part to the issue that the amount of time it takes a user to complete a repetition and the speed with which each repetition is performed may vary from user to user and may vary between two repetitions performed by the same user. As an alternative to determining the exact progress status of a repetition, motion progress status may be estimated using motion progress detector 712. For example, motion progress detector 712 may use the values of the first PC signal for the 3-axis acceleration data to determine a motion progress status for a partially completed repetition of a given exercise in real time. Motion progress status may begin at 0% at the start of a repetition, and may increase to 100%, marking the end of the repetition, with successive steps of, for example, 10%. The correlation between the first PC signal and the motion progress status for a given exercise may be determined based on previously determined relationships between a historical first PC signal and motion progress status for the given exercise (e.g., determined based on trainer motion data stored in trainer reference database 718). For example the first PC signal may be compared to the historical first PC signal when determining the motion progress status. A real-time first PC value for the first PC signal may be determined along with an indicator that specifies whether the first PC signal is presently increasing or decreasing. A historical PC value corresponding to the real-time first PC value may be identified in a region of the historical first PC signal that is either increasing or decreasing, according to the value of the indicator. A historical motion progress status may be determined for the historical first PC value (e.g., by determining the percentage of the historical repetition was completed at the time the historical first PC value was sampled), and may be used as an estimate for the motion progress status of the exercise presently being performed.

After segmenting captured motion data into repetition segments, the type of exercise being performed may be determined by exercise type recognizer 714. Due to the different mechanical constraints of exercise machines, each type of machine exercise has a certain form, which may be used to distinguish a given machine exercise from other machine exercises. Therefore, identifying a type of machine exercise may be considered a problem of classification. As explained above, a user could place a sensor tag on different exercise machines in different ways, leading to different orientations of the sensor tag. In order to perform orientation-independent classification to determine the type of exercise being performed, an acceleration magnitude signal for the 3-axis acceleration data (e.g., generated by accelerometer 138 of FIG. 2) and a rotational magnitude signal for the 3-axis gyroscope data (e.g., generated by gyroscope 140 of FIG. 2) may be determined (e.g., computed by processing circuitry 134 of FIG. 2) for each repetition of an exercise. Based on these magnitude signals, multiple features may be extracted for use as the basis for exercise type recognition by exercise type recognizer 714. For example, these extracted features may include mean, median, standard deviation, variance, skewness, kurtosis, energy, interquartile range, spectral entropy, first order derivative, second order derivative, magnitude of average rotational speed, dominant frequency, root mean square (RMS), and signal magnitude area. These features may be stored in a feature vector by exercise type recognizer 714, and the feature vector may be processed for classification to determine the exercise type being performed. As an example, the feature vector may be compared to predetermined feature vectors corresponding to a plurality of machine exercise types, and the most closely matching predetermined feature vector may be used to determine the exercise type. As another example, a sequential floating forward selection (SFFS) feature selection algorithm may be used to identify a minimal subset of features that provide the best classification accuracy when recognizing machine exercise types. As another example, a majority voting scheme may be applied to the feature vectors across multiple repetitions of a given exercise in the same session, where exercise type recognizer 714 determines the exercise type for each repetition in the session, and the most frequently determined exercise type within the session is regarded as the recognized exercise type of the session and is displayed to the user (e.g., via VR synthesis engine 704). In this way, the displayed exercise type may be resistant to erroneous exercise type determinations, which may occur as outliers.

The final stage of real-time exercise analytics engine 702 provides assessment of the quality of machine exercises performed by users. Exercise quality assessor 716 includes a trainer reference database 718. Trainer reference database 718 may store trainer models corresponding to each machine exercise with which the VR system may be used. Each trainer model may include motion data corresponding to one or more professional trainers' performances of a given exercise (referred to herein as “trainer motion data”). Comparison between this trainer motion data and captured motion data corresponding to a user's performance of an exercise (referred to herein as “user motion data”) is used by exercise quality assessor 716 as a basis for determining the quality of user's performance of the exercise. In some embodiments, at least two trainer models may be stored in trainer reference database 718 for each machine exercise, one corresponding to a female trainer performing the machine exercise, and the other corresponding to a male trainer performing the machine exercise, so that a female user may choose to use a female trainer model, and a male user may choose to use a male trainer model. It should be noted that a trainer model may be an aggregate model compiled from the trainer motion data of multiple trainers, which may improve the quality and accuracy of the trainer models over trainer models that are generated based on only a single trainer's motion data.

In order to determine similarities between a trainer model and user motion data, a motion trajectory based approach may be used. For example, user motion data corresponding to a user's performance of a given exercise may be divided into repetition segments (e.g., by repetition segmentor 708) and each repetition segment may further be divided into a sequence of small fixed-length windows, each having a period that is smaller than the duration of the repetition segment itself (e.g., the duration of a repetition segment may be between 3-5 seconds depending on the machine exercise, while the window duration may be 0.5 seconds). Then, a number of features may be extracted from each window in order to capture intrinsic characteristics of each repetition. These extracted features may be stored in a local feature vector for each respective window and, thereby, a sequence of local feature vectors may be formed, which forms a motion trajectory in the feature space. A trajectory comparison algorithm may be applied to this motion trajectory in order to quantify the similarity between two motion trajectories. In this way, quality assessment performed by exercise quality assessor 716 may provide fine-grained descriptions about where a user's exercise repetition differs from the trainer model, and the user may be provided with concrete feedback on how their exercise quality may be improved.

For example, the extracted features used to form a local feature vector for a window may include average of movement intensity (AI), variation of movement intensity (VI), smoothness of movement intensity (SI), average acceleration energy (AAE), and average rotation energy (ARE). AI may be computed as the average of motion intensity (MI) defined as the Euclidian norm of the acceleration vector. AI measures the average strength level of the exercise repetition. VI is computed as the variation of MI. VI measures the strength variation of the exercise repetition. SI is computed as the derivative values of MI. SI measures the smoothness of the exercise repetition. AAE calculates the mean value of energy over the three accelerometer axes. AAE measures the total exercise acceleration energy. ARE calculates the mean value of energy over the three gyroscope axes. ARE measures the total exercise rotation energy.

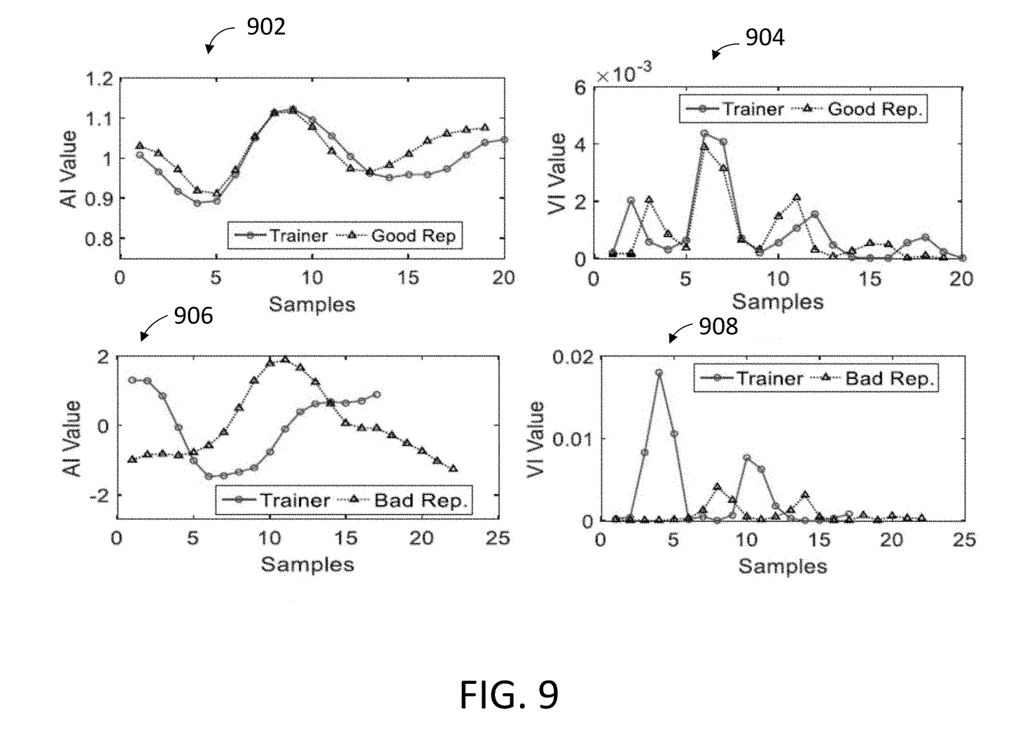

Examples of sampled AI and VI values that may be used as a basis for exercise quality assessment are depicted in the graphs of FIG. 9, in which multiple graphs illustrating comparisons of user motion data with trainer models are shown. Graphs 902, 904, 906, and 908 collectively provide examples of AI and VI values derived from user motion data corresponding to both “good reps” (i.e., high quality exercise repetitions; user motion data is closely match with trainer motion data) and “bad reps” (i.e., low quality exercise repetitions; user motion data is mismatched with the trainer motion data).

Graph 902 shows the AI value over time for user motion data corresponding to a user's performance of one repetition of a leg extension machine exercise compared to the AI value over time for a corresponding trainer model for the leg extension machine exercise.

Graph 904 shows the VI value over time for user motion data corresponding to a user's performance of one repetition of a leg extension machine exercise compared to the VI value over time for a corresponding trainer model for the leg extension machine exercise.

As shown, the user motion data for both graph 902 and graph 904 appear to be closely match the trainer model, indicating that the user's repetition of the leg extension machine exercise should be considered a good or high quality repetition.

Graph 906 shows the AI value over time for user motion data corresponding to a user's performance of one repetition of a bicep curl machine exercise compared to the AI value over time for a corresponding trainer model for the bicep curl machine exercise.

Graph 908 shows the AI value over time for user motion data corresponding to a user's performance of one repetition of a bicep curl machine exercise compared to the AI value over time for a corresponding trainer model for the bicep curl machine exercise.

As shown, the user motion data for both graph 906 and graph 908 appear to be mismatched with the trainer model, indicating that the user's repetition of the bicep curl machine exercise should be considered a bad or low quality repetition.

Returning now to FIG. 7, the goal of motion trajectory comparison performed by exercise quality assessor 716 is to quantify similarities between the motion trajectory determined from a user's repetition of a machine exercise and the motion trajectory determined from a trainer model corresponding to the machine exercise in order to determine the quality of the user's performance of the machine exercise. One challenging aspect of this motion trajectory comparison involves comparing motion trajectories from two repetition segments of different lengths. In order to accurately perform motion trajectory comparison in such scenarios, a multidimensional dynamic time warping (DTW) technique may be used. DTW is a nonlinear alignment technique for measuring similarity between two signals having different lengths. When applied to the present system, DTW is used to cope with different motion trajectory lengths. For example, let X denote the motion trajectory of the trainer model, and let Y denote the motion trajectory of the user motion data:

X=x₁, x₂, . . . , xᵢ, . . . , x_{M}

Y=y₁, y₂, . . . , yⱼ, . . . y_{N}

where xᵢ and yᵢ represent the i^{th} and j^{th} local feature vector in X and Y respectively, and where M and N represent the length of X and Y respectively. DTW compensates for the length difference between X and Y by solving the following dynamic programming (DP) problem:

D(i, j)=min{D(i−1, j−1), D(i−1, j), D(i, j−1)}+d(i, j)

where d(i, j) represents the distance function which measures the local difference between local feature vectors xᵢ and yᵢ in the feature space, and D(i, j) represents the cumulative global distance between sub-trajectories {x₁, x₂, . . . , xᵢ} and {y₁, y₂, . . . , yⱼ}. The solution of the DP problem is the cumulative distance between the two motion trajectories X and Y, which is located within D(M, N) and a warp path W of length K defined as:

W=w₁, w₂, . . . , wₖ, . . . , W_{K}

which traces the mapping between X and Y. Since the cumulative D(M, N) is dependent on the length of the warp path W, D(M, N) may be normalized by dividing D(M, N) by the warp path length K and using this averaged cumulative distance as the metric for measuring the distance between motion trajectories X and Y as:

Dist(X, Y)=[D(M, N)]/K

The cosine distance may be used as the local distance function defined as:

d(i, j)=1−[(xᵢ^{T}*yⱼ)/(∥xᵢ∥*∥yᵢ∥]

Compared to other distance functions, the cosine distance may provide an advantage of having an intrinsic range of [0, 1], which in turn should cause the averaged cumulative distance Dist(X, Y) to be in the range [0, 1], which may therefore be interpreted as the dissimilarity between X and Y in terms of percentile. Therefore, the similarity score between X and Y, Sim(X, Y), may be defined as:

Sim(X, Y)=1−Dist(X, Y)

This similarity score, as applied to a comparison between the motion trajectories of user motion data and a training model, is indicative of the quality of the user's performance of a repetition of a machine exercise and, thus applied, acts as the quantification of exercise quality. For example, the similarity score may be presented to the user (e.g., as part of a HUD of a VR environment) as a percentage, indicating the quality of a repetition of the exercise being performed. Alternatively, a running average of consecutive similarity scores may be displayed to the user in order to indicate the quality of the user's performance of the exercise across multiple repetitions of the exercise.

VR synthesis engine 704 includes a VR scene manager 720, an exercise information visualizer 726, and a virtual body animator 728. VR scene manager 720 includes an exercise type database 722 and a personal configuration database 724. Once a user begins exercising, VR scene manager 720 may automatically initiate a virtual coaching scene based on the exercise type determined by exercise type recognizer 714. For example, VR scene manager 720 retrieve a virtual coaching scene corresponding to the determined exercise type from exercise type database 722. Additionally, user-defined preferences related to the virtual coaching scene may be retrieved by VR scene manager 720 from personal configuration database 724. For example, these user-defined preferences may correspond to user customization of the avatar that is displayed, the information that is displayed, or the background of the virtual coaching scene.

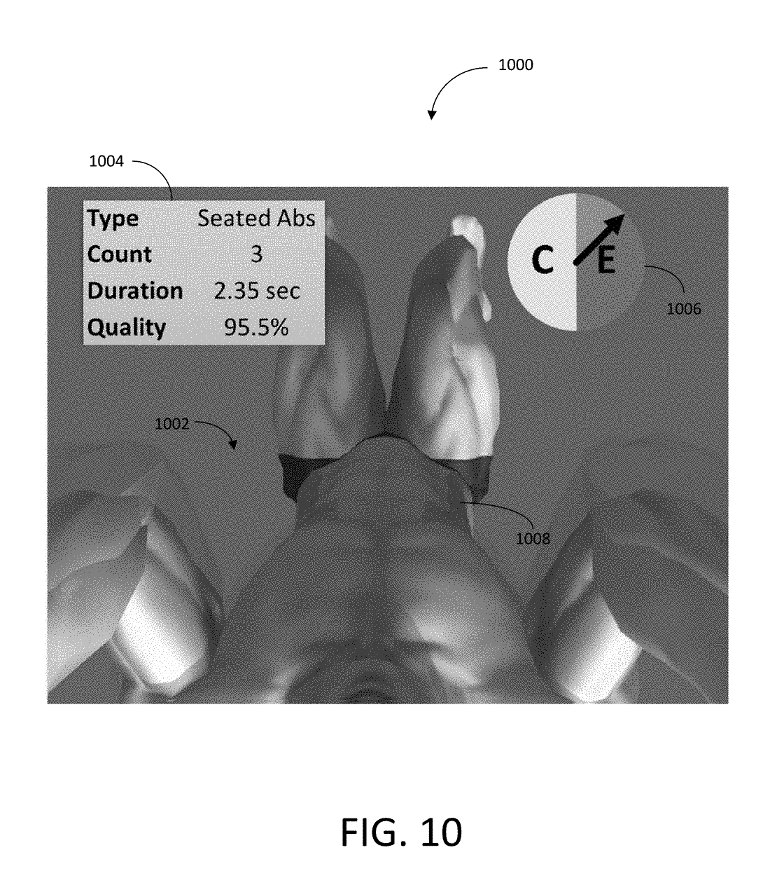

An example of a virtual coaching scene that may be generated and displayed by VR scene manager 720 is shown in FIG. 10. Virtual coaching scene 1000 corresponds to a seated abs machine exercise. Virtual body animator 728 generates a virtual avatar (e.g., a body) of a user that follows the user's movement during the exercise in substantially real-time according to motion progress status values generated by motion progress detector 712. Highlighted muscle groups 1008 correspond to muscle groups that are activated by the machine exercise being performed (in the present case, seated abs) and may be highlighted by virtual body animator 728 so that the user may intuitively understand the muscle groups that should be activated during performance of the machine exercise. Virtual body animator 728 may, for example, determine which muscle groups to activate according to corresponding data stored in exercise type database 722. Block 1004 may be part of a HUD generated by VR scene manager 720, and may include exercise information such as values for exercise type, repetition count, exercise duration, and exercise quality (e.g., the similarity score or a running average of multiple consecutive similarity scores), which may be populated by exercise information visualizer 726 based on corresponding values generated by repetition counter 710, exercise quality assessor 716, and exercise type recognizer 714. Progress gauge 1006 may provide a pace breakdown for a user by displaying two phases in a repetition: eccentric (E) and concentric (C). In some embodiments, pacing guidelines may be displayed to the user through the HUD, indicating if an exercise is being performed to quickly or two slowly.

The present invention has been described in terms of one or more preferred embodiments, and it should be appreciated that many equivalents, alternatives, variations, and modifications, aside from those expressly stated, are possible and within the scope of the invention.

1. A method comprising:
with a sensor device, detecting motion and generating motion data based on the detected motion;
with an electronic device, receiving the motion data from the sensor device;
with a processor in the electronic device, analyzing the motion data to produce analytics information;
with the processor, generating a virtual reality (VR) environment in which analytics information is provided; and
with an electronic display in the electronic device, displaying the VR environment.

2. The method of claim 1, wherein analyzing the motion data to produce the analytics information comprises:
segmenting the motion data into repetition segments, each corresponding to a single repetition of an exercise;
generating a repetition count corresponding to a quantity of the repetition segments;
generating a motion progress status corresponding to a percentage of a given repetition that has been completed in real-time;
determining an exercise type based on the motion data; and
determining exercise quality based on the motion data.

3. The method of claim 2, wherein the motion data comprises acceleration data, and wherein segmenting the motion data to produce the repetition segments comprises:
performing principle component analysis on the acceleration data to generate a first principle component signal; and
identifying a repetition segment of the motion data corresponding to a first repetition of the exercise based on the first principle component signal and the acceleration data.

4. The method of claim 3, wherein generating the motion progress status comprises:
generating the motion progress status based on a comparison between the first principle component signal to a historical first principle component signal.

5. The method of claim 3, wherein the motion data further comprises gyroscope data, and wherein determining the exercise type based on the motion data comprises:
generating an acceleration magnitude signal for the acceleration data;
generating a rotational magnitude signal for the gyroscope data;
extracting features from the acceleration magnitude signal and the rotational magnitude signal to generate a feature vector; and
analyzing the feature vector to determine the exercise type by applying a majority voting scheme to the feature vector for multiple repetitions of the exercise.

6. The method of claim 2, wherein determining exercise quality based on the motion data comprises:
comparing the motion data to a trainer model stored in a non-transitory memory of the electronic device.

7. The method of claim 6, wherein comparing the motion data to the trainer model comprises:
dividing the repetition segments into smaller fixed-length windows;
generating a first motion trajectory for the motion data by extracting features from each window of the windows to generate a sequence of local feature vectors; and
performing trajectory comparison on the first motion trajectory and a second motion trajectory of the trainer model.

8. The method of claim 7, wherein the trajectory comparison comprises multidimensional dynamic time warping.

9. The method of claim 2, wherein generating the VR environment comprises:
animating an avatar that moves in real-time corresponding to the motion data;
highlighting muscle groups on the avatar that correspond to muscles activated by the determined exercise type; and
generating a heads-up display (HUD) that includes the repetition count, the motion progress status, the exercise type, and the exercise quality.

10. A system comprising:
a sensor device that captures motion data corresponding to motion of an exercise machine; and
an electronic device that receives the motion data from the sensor device, the electronic device comprising:
a processor connected to a memory having instructions stored thereon which, when executed by the processor, cause the processor to analyze the motion data to produce analytics information, and generate a virtual reality (VR) environment in which the analytics information is provided; and
an electronic display electrically coupled to the processor to display the VR environment generated by the processor.

11. The system of claim 10, wherein the sensor device comprises a magnet that attaches the sensor device to the exercise machine.

12. The system of claim 10, wherein the sensor device comprises:
wireless communications circuitry that provides the motion data to the electronic device via Bluetooth Low Energy.

13. The system of claim 10, wherein the instructions, when executed by the processor, further cause the processor to:
segment the motion data into repetition segments, each corresponding to a single repetition of an exercise;
generate a repetition count corresponding to a quantity of the repetition segments;
generate a motion progress status corresponding to a percentage of a given repetition that has been completed in real-time;
determine an exercise type based on the motion data; and
determine exercise quality based on the motion data.

14. The system of claim 13, wherein the instructions, when executed by the processor, further cause the processor to:
divide the repetition segments into smaller fixed-length windows;
generate a first motion trajectory for the motion data by extracting features from each window of the windows to generate a sequence of local feature vectors; and
perform trajectory comparison on the first motion trajectory and a second motion trajectory of a trainer model to determine the exercise quality, wherein the trainer model is stored in a trainer reference database in a non-transitory memory of the electronic device.

15. The system of claim 10, wherein the sensor device further comprises:
an accelerometer that generates acceleration data; and
a gyroscope that generates gyroscope data, wherein the captured motion data comprises the acceleration data and the gyroscope data.

16. A head-mounted display (HMD) device comprising:
a processor connected to a memory having instructions stored thereon which, when executed by the processor, cause the processor to analyze captured motion data to produce analytics information, and generate a virtual reality (VR) environment in which the analytics information is provided; and
an electronic display electrically coupled to the processor to display the VR environment generated by the processor.

17. The HMD device of claim 16, wherein the memory contains further instructions which, when executed by the processor, cause the processor to:
segment the motion data into repetition segments, each corresponding to a single repetition of an exercise;
generate a repetition count corresponding to a quantity of the repetition segments;
generate a motion progress status corresponding to a percentage of a given repetition that has been completed in real-time;
determine an exercise type based on the motion data; and
determine exercise quality based on the motion data.

18. The HMD device of claim 17, wherein the memory contains further instructions which, when executed by the processor, cause the processor to:
divide the repetition segments into smaller fixed-length windows;
generate a first motion trajectory for the motion data by extracting features from each window of the windows to generate a sequence of local feature vectors; and
perform trajectory comparison on the first motion trajectory and a second motion trajectory of a trainer model to determine the exercise quality.

19. The HMD device of claim 18, further comprising:
a non-transitory computer readable storage medium, wherein the trainer model is stored in a trainer reference database in a non-transitory computer readable storage medium.

20. The HMD device of claim 18, wherein the VR environment comprises:
an animated avatar that moves in real-time corresponding to the motion data to perform the exercise, wherein the animated avatar comprises highlighted muscle groups corresponding to muscles activated by the determined exercise type; and
